(19) United States
(12) Patent Application Publication
(10) Pub. No.: US 2024/0406768 A1
(43) Pub. Date: Dec. 5, 2024

(54) DRIVE TEST BASED NETWORK PERFORMANCE ESTIMATION

(71) Applicant: DISH Wireless L.L.C., Englewood, CO (US)

(72) Inventors: Oscar Leonardo Rodriguez Gomez, Littleton, CO (US); David Ricardo Bentolila Sapiani, Littleton, CO (US); Omar Ricardo Amaya Gonzalez, Littleton, CO (US)

(21) Appl. No.: 18/327,776

(22) Filed: Jun. 1, 2023

(51) Int. Cl. H04W 24/06; H04L 41/14; H04L 43/08

(52) U.S. Cl. CPC H04W 24/06; H04L 41/145; H04L 43/08

(57) ABSTRACT

Technologies for estimating performance for a communications network are disclosed. An example method includes obtaining a proposed entire coverage of the communications network, and prior to live traffic being generated by users on the communications network: determining a drive test pattern commensurate with the proposed entire coverage, causing performance of drive tests in accordance with the drive test pattern, and in real-time: analyzing drive test data from the drive tests, and generating emulated network performance metrics for the communications network based on the analyzing of the drive test data.

### BACKGROUND

In telecommunications, 5G is the fifth-generation technology standard for broadband cellular networks. 5G networks are cellular networks, in which the service area is divided into small geographical areas called cells. 5G wireless devices in a cell can communicate by radio waves with a cellular base station (e.g., located on a cellular tower) via fixed antennas, over frequency channels. The base stations can be connected to switching centers in the telephone network and routers for Internet access by high-bandwidth optical fiber or wireless backhaul connections. There is a need for technologies that facilitate efficient estimation or prediction of network performance in anticipation of the deployment of a new network service or function.

### BRIEF SUMMARY

In some implementations of a communications network (e.g., a 5G network), the entirety or at least some components or elements of the network core (e.g., 5G core) can be implemented logically or virtually, via one or more cloud service providers. The network core communicates with various cell sites that are located in different geographic or network locations, subjecting to control of same or different entities. Communications network traffic typically leads to building key performance indicators (KPIs) and other tools to monitor the network performance live. Without a sufficient number of users using the network (e.g., prior to live network environment upon the official deployment of the network (or a corresponding network service or function)) to generate traffic, however, it is a challenging task to predict, estimate, or otherwise determine how the network will perform once it becomes live.

In some embodiments, a computer-implemented method for estimating performance of a communications network includes obtaining a proposed entire coverage of the communications network. The method also includes prior to live traffic being generated by users on the communications network: determining a drive test pattern commensurate with the proposed entire coverage of the communications network; causing performance of a plurality of drive tests in accordance with the drive test pattern; and in real-time: analyzing drive test data from the plurality of drive tests; and generating emulated network performance metrics for the communications network based on the analyzing of the drive test data.

In some embodiments, the proposed entire coverage of the communications network includes an entirety of proposed geographic regions to be served by the communications network upon its deployment. In some embodiments, determining the drive test pattern comprises identifying publicly accessible surface pathways based on the proposed geographic regions. In some embodiments, determining the drive test pattern comprises associating respective time windows and drive test devices with different portions of the identified surface pathways. In some embodiments, the respective time windows and drive test devices are determined based on at least one of a real-time processing constraint, drive test device accessibility constraint, or performance metrics density requirement.

In some embodiments, causing performance of the plurality of drive tests in accordance with the drive test pattern comprises causing performance of at least two of the drive tests in a temporally parallel or partially overlapping manner.

In some embodiments, the emulated network performance metrics emulate KPIs that are computed based on live traffic generated by users on the communications network.

In some embodiments, the method includes classifying failures of the communications network based on the emulated network performance metrics, prior to live traffic being generated by users on the communications network. In some embodiments, classifying failures comprises creating scenarios to simulate the failures based on root cause analysis of one or more errors using the emulated network performance metrics. In some embodiments, the method includes identifying potential remedial actions with respect to one or more of the failures.

In some embodiments, a network performance estimation system for a communications network includes at least one memory that stores computer executable instructions; and at least one processor that executes the computer executable instructions to cause actions to be performed. The actions includes obtaining a proposed entire coverage of a service or function of the communications network; prior to live traffic being generated on the communications network by users subscribed to the service or function: determining a drive test pattern commensurate with the proposed entire coverage; causing performance of a plurality of drive tests in accordance with the drive test pattern; analyzing drive test data from the plurality of drive tests; and generating emulated network performance metrics for the service or function of communications network based on the analyzing of the drive test data.

In some embodiments, the proposed entire coverage includes an entirety of proposed geographic regions to be served by the service or function upon its deployment. In some embodiments, determining the drive test pattern comprises identifying publicly accessible surface pathways based on the proposed geographic regions. In some embodiments, determining the drive test pattern comprises associating respective time windows and drive test devices with different portions of the identified surface pathways. In some embodiments, the respective time windows and drive test devices are determined based on at least one of a real-time processing constraint, drive test device accessibility constraint, or performance metrics density requirement.

In some embodiments, causing performance of the plurality of drive tests in accordance with the drive test pattern comprises causing performance of at least two of the drive tests in a temporally parallel or partially overlapping manner.

In some embodiments, the emulated network performance metrics emulate KPIs that are computed based on live traffic generated by users on the communications network.

In some embodiments, a non-transitory computer-readable medium stores contents that, when executed by one or more processors, cause actions to be performed. The actions include obtaining a proposed entire coverage of a service or function of the communications network; prior to live traffic being generated on the communications network by users subscribed to the service or function: determining a drive test pattern commensurate with the proposed entire coverage; causing performance of a plurality of drive tests in accordance with the drive test pattern; analyzing drive test data from the plurality of drive tests; and generating emulated network performance metrics for the service or function of communications network based on the analyzing of the drive test data.

In some embodiments, causing performance of the plurality of drive tests in accordance with the drive test pattern comprises causing performance of at least two of the drive tests in a temporally parallel or partially overlapping manner.

In some embodiments, the actions include classifying failures of the communications network based on the emulated network performance metrics, prior to live traffic being generated by users on the communications network by users subscribed to the service or function.

### BRIEF DESCRIPTION OF THE DRAWINGS

FIG. 1 is a block diagram illustrating an example networked environment for performance estimation for a communications network in accordance with some embodiments of the techniques described herein.

FIG. 2 is a flow diagram depicting an example process for estimating performance of a communications network in accordance with some embodiments of the techniques described herein.

FIG. 3 illustrates an example representation of proposed coverage of a communications network in accordance with some embodiments of the techniques described herein.

FIG. 4 is a block diagram illustrating elements of an example computing device utilized in accordance with some embodiments of the techniques described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks and the environment, have not been shown or described in order to avoid unnecessarily obscuring descriptions of the embodiments. Additionally, the various embodiments may be methods, systems, media, or devices. Accordingly, the various embodiments may combine software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

References to the term “set” (e.g., “a set of items”), as used herein, unless otherwise noted or contradicted by context, is to be construed as a nonempty collection comprising one or more members or instances.

References to the term “subset” (e.g., “a subset of the set of items”), as used herein, unless otherwise noted or contradicted by context, is to be construed as a nonempty collection comprising one or more members or instances of a set or plurality of members or instances.

Moreover, the term “subset,” as used herein, refers to a proper subset, which is a collection of one or more members or instances that are collectively smaller in number than the set or plurality of which the subset is drawn. For instance, a subset of a set of ten items will have less than ten items and at least one item.

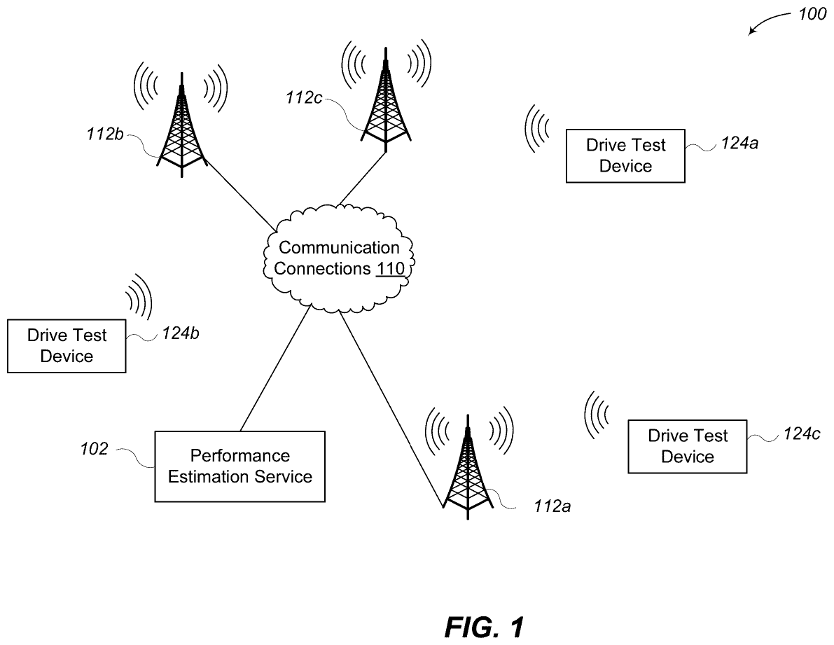

FIG. 1 is a block diagram illustrating an example networked environment 100 for performance estimation for a communications network in accordance with some embodiments of the techniques described herein. Environment 100 includes a plurality of cells 112a-112c, a plurality of drive test devices 124a-124b, a performance estimation service 102, and communication connections 110. Illustratively, the cells 112a-112c correspond to cell sites (e.g., cellular towers) that together implement a proposed 5G cellular communications network (or at least a service or function thereof). The cells 112a-112c may include or be in communication with base stations, radio back haul equipment, antennas, or other devices, which are not illustrated for case of discussion.

Each cell 112 provides 5G compatible cellular communications over a coverage area. The coverage area of each cell 112 may vary depending on the elevation antenna of the cell, the height of the antenna of the cell above the ground, the electrical tilt of the antenna, the transmit power utilized by the cell, or other capabilities that can be different from one type of cell to another or from one type of hardware to another. Although embodiments are directed to 5G cellular communications, embodiments are not so limited and other types of cellular communications technology may also be utilized or implemented. In various embodiments, the cells 112a-112c may communicate with each other via communication connections 110. Communication connections 110 include one or more wired or wireless networks, which may include a series of smaller or private connected networks that carry information between the cells 112a-112c.

The drive test devices 124a-124c are mobile radio network air interface measurement equipment that can detect and record a wide variety of the physical and virtual parameters of mobile cellular service in a given geographical area, e.g., by communicating with one or more of the cells 112a-112c. One or more drive test devices can be installed on a mobile vehicle (e.g., mounted to a car, truck, or van that may or may not be autonomous) or be used as portable device(s) (e.g., carried by a person). The drive test devices can include highly specialized electronic devices that interface to OEM mobile handsets or other user equipment (UE), to facilitate measurements that are comparable to actual experiences of a user of the network. In various embodiments, the data collected by a drive test device during drive testing can include signal levels, signal quality, interference, dropped calls, blocked calls, anomalous events, call statistics, service level statistics, quality of service (QOS) information, handover information, neighboring cell information, GPS location co-ordinates, combination of the same or the like.

In various embodiments, the performance estimation service 102 can include one or more computing devices to implement the network performance estimation related functions described herein. In various embodiments, the performance estimation service 102 interfaces or otherwise communicates with one or more elements of the 5G network core via the communication connections 110, with drive test devices (such as devices 124a-124c) directly or indirectly, with cell sites (e.g., cellular towers or controllers thereof), with other systems or devices external to the 5G network, or with a combination thereof. In some embodiments, the performance estimation service 102 is partly or entirely implemented inside or outside the 5G network core. In some embodiments, at least part of the performance estimation service 102 is implemented by one or more of drive test devices.

The above description of the exemplary networked environment 100 and the various services, systems, networks, and devices therein is intended as a broad, non-limiting overview of an example environment in which various embodiments of the presently disclosed technologies may be implemented. FIG. 1 illustrates just one example of an operating environment, and the various embodiments discussed herein are not limited to such an environment. In particular, the networked environment 100 may contain other devices, systems, or media not specifically described herein.

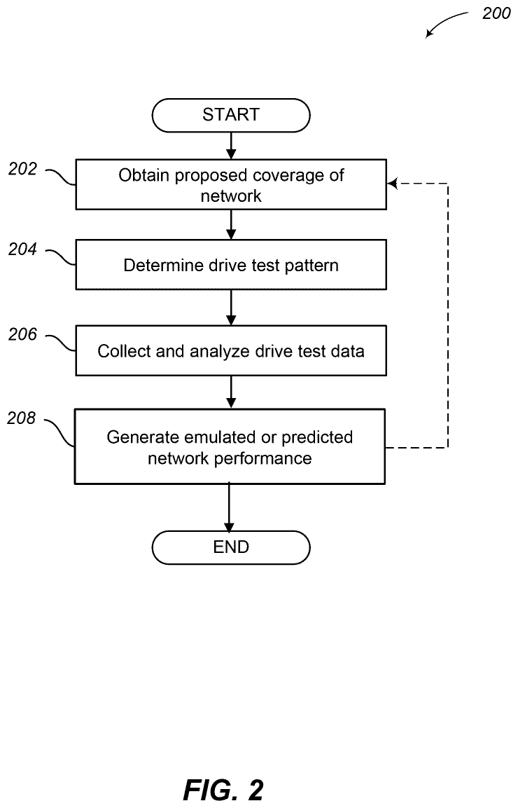

FIG. 2 is a flow diagram depicting an example process 200 for estimating performance of a communications network (e.g., a 5G network as described above) in accordance with some embodiments of the techniques described herein. In various embodiments, the process 200 is performed in real time and based on drive tests using, e.g., drive test devices 124a-124c. In various embodiments, the drive tests performed herein are not responsive to network failures or issues that are reported by users of a live network or otherwise detected by a live network, are not implemented to verify or assess network coverage, capacity, quality, or performance after deployment of a new network or its service, function, upgrade, or configuration, are not directed to benchmark, optimize, or troubleshoot a network with live network communication traffic generated by subscribed users; rather, the drive tests are used as a basis for emulating, predicting, or otherwise estimating performance of a network prior to live traffic of users. Illustratively, at least some part of the process 200 can be implemented by the performance estimation service 102, or one or more drive test devices 124a-124c of FIG. 1.

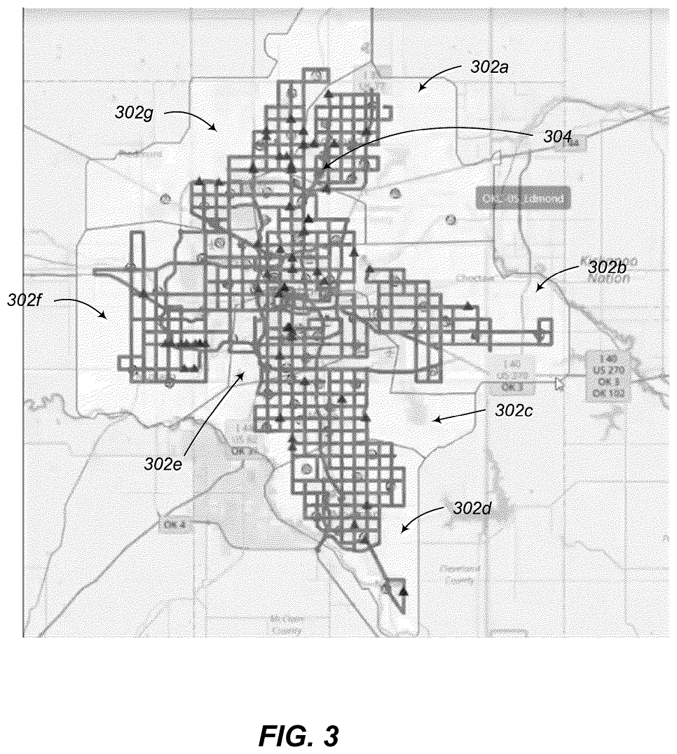

The process 200 starts at block 202, which includes obtaining a proposed coverage of the communications network (or one of its services, functions, upgrades, or configurations). In some embodiments, the proposed coverage is the entire and complete coverage (e.g., service-wide coverage, district-wide coverage, nation-wide coverage, world-wide coverage, or the like) proposed for the communications network. Illustratively, the proposed coverage can include multiple proposed geographic regions or footprints to be served by the communications network (or one of its services, functions, upgrades, or configurations) upon its deployment. FIG. 3 illustrates an example representation of proposed coverage including multiple proposed geographic regions 302a-302g to be served by a communications network. In various embodiments, the proposed geographic regions may or may not be bordering or otherwise connected with one another.

At block 204, the process 200 includes determining a drive test pattern. A drive test pattern can include one or more routes, connected or unconnected to one another, in which one or more drive test devices can be moved along to collect data regarding the communications network. Illustratively, this is performed prior to live traffic being generated by users on the communications network. For example, the drive test patterns are determined prior to the deployment of the network (or one of its services, functions, upgrades, or configurations), prior to a sufficient number of subscribed users (e.g., below a threshold number), or prior to a sufficient number of user devices being connected to use the network accordingly. In some embodiments, the drive test pattern is determined in a manner commensurate with the proposed coverage; in other words, the drive test pattern is not sporadic or targeted on certain part(s) of the proposed coverage.

In some embodiments, determining the drive test pattern includes identifying publicly accessible roads, railways, waterways, or other surface pathways, based on the proposed geographic regions. In some embodiments, respective time windows for drive testing as well as drive test devices are associated with different portions of the identified surface pathways. The different portions of the identified surface pathways may or may not correspond to the different geographic regions of the proposed coverage.

Illustratively, the respective time windows and drive test devices are determined based on a real-time processing constraint, drive test device accessibility constraint, performance metrics density requirement, or other factors. For example, some real-time processing constraint may require smaller time windows with a larger number of drive test devices to perform drive test simultaneously to cover the identified surface pathways. Some drive test device accessibility constraint may limit a maximum number of drive test devices that can be dispatched at a certain time, in a certain region, or to measure certain radio frequency bands. Certain performance metrics density requirement may allow for a subset (e.g., major roads) of the identified surface pathways to be drive tested, while bypassing or skipping others.

The performance estimation service 102 can cause performance of one or more drive tests in accordance with the drive test pattern. In some embodiments, at least two of the drive tests (e.g., for the same or different geographic regions) are performed in a temporally parallel or partially overlapping manner. Illustratively, the performance estimation service 102 can control or request dispatch of drive test devices, indicate destinations or routes to move along, specify tasks to perform to collect data, combination of the same or the like.

At block 206, the process 200 includes collecting and analyzing drive test data. In some embodiments, the collection and analysis of drive test data from the drive tests are performed in real-time. In some embodiments, the analysis is at least partly performed locally on individual drive test devices (e.g., pre-processing, filtering, pattern recognition, or the like) prior to transmission to the performance estimation service 102. As illustrated in FIG. 3, a collection of surface pathways 304 represents the routes along with drive test data collected for the entire proposed coverage. In various embodiments, the collecting and analyzing of drive test data includes merging drive test data from different geographic regions (e.g., regions 302a-302g of FIG. 3) to form the collection of surface pathways 304, as well as to identify network issues relative to the collection of surface pathways.

At block 208, the process 200 includes generating emulated, predicted, or otherwise estimated network performance metrics based on the analysis of the drive test data. In some embodiments, the metrics are generated in real-time, which emulate, predict, or otherwise estimate KPIs that are computed based on live traffic generated by users on the communications network (e.g., after network deployment). In some embodiments, the process 200 includes classifying failures of the communications network based on the network performance metrics, prior to live traffic being generated by users on the communications network. Illustratively, classifying such failures can include creating scenarios to simulate the failures based on root cause analysis of one or more errors using the network performance metrics. In some embodiments, potential remedial actions with respect to one or more of the failures can be identified.

In some embodiments, the process 200 includes proceeding back to block 202, where proposed coverage for a new service, function, upgrade, or configuration of the communications network, or for a completely new communications network is obtained.

The various operations depicted via FIG. 2, as well as those described elsewhere herein, may be altered in a variety of ways. For example, the particular order of the operations may be rearranged; some operations may be performed in parallel; shown operations may be omitted, or other operations may be included; a shown operation may be divided into one or more component operations, or multiple shown operations may be combined into a single operation, etc.

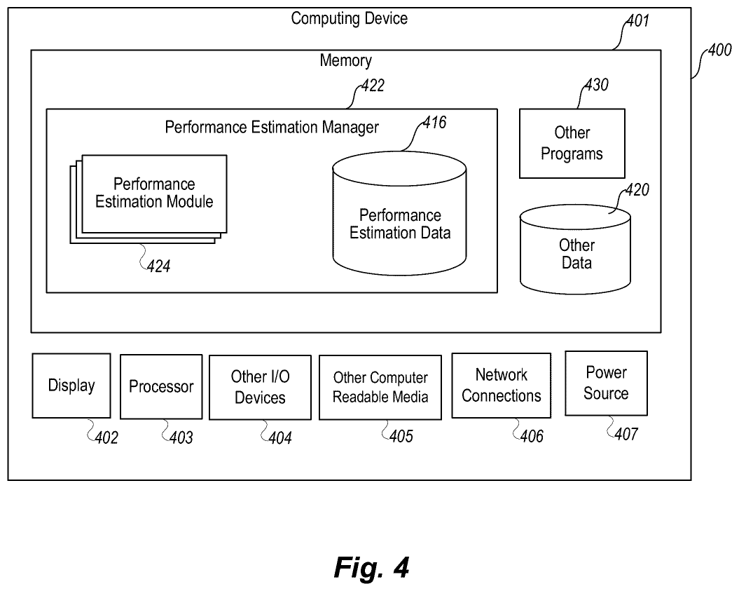

FIG. 4 is a block diagram illustrating elements of an example computing device 400 utilized in accordance with some embodiments of the techniques described herein. Illustratively, the computing device 400 corresponds to a performance estimation service 102, one of test drive devices 124a-124c, or at least a part thereof.

In some embodiments, one or more general purpose or special purpose computing systems or devices may be used to implement the computing device 400. In addition, in some embodiments, the computing device 400 may comprise one or more distinct computing systems or devices, and may span distributed locations. Furthermore, each block shown in FIG. 4 may represent one or more such blocks as appropriate to a specific embodiment or may be combined with other blocks. Also, the performance estimation manager 422 may be implemented in software, hardware, firmware, or in some combination to achieve the capabilities described herein.

As shown, the computing device 400 comprises a computer memory (“memory”) 401, a display 402 (including, but not limited to a light emitting diode (LED) panel, cathode ray tube (CRT) display, liquid crystal display (LCD), touch screen display, projector, etc.), one or more Central Processing Units (CPU) or other processors 403, Input/Output (I/O) devices 404 (e.g., keyboard, mouse, RF or infrared receiver, universal serial bus (USB) ports, High-Definition Multimedia Interface (HDMI) ports, other communication ports, and the like), other computer-readable media 405, network connections 406, a power source (or interface to a power source) 407. The performance estimation manager 422 is shown residing in memory 401. In other embodiments, some portion of the contents and some, or all, of the components of the performance estimation manager 422 may be stored on and/or transmitted over the other computer-readable media 405. The components of the computing device 400 and performance estimation manager 422 can execute on one or more processors 403 and implement applicable functions described herein. In some embodiments, the performance estimation manager 422 may operate as, be part of, or work in conjunction and/or cooperation with other software applications stored in memory 401 or on various other computing devices. In some embodiments, the performance estimation manager 422 also facilitates communication with peripheral devices via the I/O devices 404, or with another device or system via the network connections 406.

The one or more performance estimation modules 424 is configured to perform actions related, directly or indirectly, to drive test-based network performance estimation as described herein. In some embodiments, the performance estimation module(s) 424 stores, retrieves, or otherwise accesses at least some performance estimation-related data on some portion of the performance estimation data storage 416 or other data storage internal or external to the computing device 400. In various embodiments, at least some of the performance estimation modules 424 may be implemented in software or hardware.

Other code or programs 430 (e.g., further data processing modules, communication modules, a Web server, and the like), and potentially other data repositories, such as data repository 420 for storing other data, may also reside in the memory 401, and can execute on one or more processors 403. Of note, one or more of the components in FIG. 4 may or may not be present in any specific implementation. For example, some embodiments may not provide other computer readable media 405 or a display 402.

In some embodiments, the computing device 400 and performance estimation manager 422 include API(s) that provides programmatic access to add, remove, or change one or more functions of the computing device 400. In some embodiments, components/modules of the computing device 400 and performance estimation manager 422 are implemented using standard programming techniques. For example, the performance estimation manager 422 may be implemented as an executable running on the processor(s) 403, along with one or more static or dynamic libraries. In other embodiments, the computing device 400 and performance estimation manager 422 may be implemented as instructions processed by a virtual machine that executes as one of the other programs 430. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), or declarative (e.g., SQL, Prolog, and the like).

In a software or firmware implementation, instructions stored in a memory configure, when executed, one or more processors of the computing device 400 to perform the functions of the performance estimation manager 422. In some embodiments, instructions cause the one or more processors 403 or some other processor(s), such as an I/O controller/processor, to perform at least some functions described herein.

The embodiments described above may also use well-known or other synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs or other processors. Some embodiments may execute concurrently and asynchronously, and communicate using message passing techniques. Equivalent synchronous embodiments are also supported by a performance estimation manager 422 implementation. Also, other functions could be implemented and/or performed by each component/module, and in different orders, and by different components/modules, yet still achieve the functions of the computing device 400 and performance estimation manager 422.

In addition, programming interfaces to the data stored as part of the computing device 400 and performance estimation manager 422, can be available by standard mechanisms such as through C, C++, C#, and Java APIs; libraries for accessing files, databases, or other data repositories; scripting languages such as XML; or Web servers, FTP servers, NFS file servers, or other types of servers providing access to stored data. The performance estimation data storage 416 and data repository 420 may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible. Other functionality could also be provided by each component/module, or existing functionality could be distributed amongst the components/modules in different ways, yet still achieve the functions of the performance estimation manager 422.

Furthermore, in some embodiments, some or all of the components of the computing device 400 and performance estimation manager 422 may be implemented or provided in other manners, such as at least partially in firmware and/or hardware, including, but not limited to one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use, or provide the contents to perform, at least some of the described techniques.

The various embodiments described above can be combined to provide further embodiments. All of the U.S. patents. U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method for estimating performance of a communications network, the method comprising:
obtaining a proposed entire coverage of the communications network;
prior to deployment of the communications network:
determining a drive test pattern including a plurality of routes commensurate with the proposed entire coverage of the communications network;
causing performance of a plurality of drive tests in accordance with the drive test pattern; and
in real-time with data capturing by one or more of the plurality of drive tests:
analyzing drive test data from the plurality of drive tests; and
generating emulated network performance metrics for the communications network based on the analyzing of the drive test data.

2. The method of claim 1, wherein the proposed entire coverage of the communications network includes an entirety of proposed geographic regions to be served by the communications network upon its deployment.

3. The method of claim 2, wherein determining the drive test pattern comprises identifying publicly accessible surface pathways based on the proposed geographic regions.

4. The method of claim 3, wherein determining the drive test pattern comprises associating respective time windows and drive test devices with different portions of the identified surface pathways.

5. The method of claim 4, wherein the respective time windows and drive test devices are determined based on at least one of a real-time processing constraint, drive test device accessibility constraint, or performance metrics density requirement.

6. The method of claim 1, wherein causing performance of the plurality of drive tests in accordance with the drive test pattern comprises causing performance of at least two of the drive tests in a temporally parallel or partially overlapping manner.

7. The method of claim 1, wherein the emulated network performance metrics emulate key performance indicators (KPIs) that are computed based on live traffic generated by users on the communications network.

8. The method of claim 1, comprising classifying failures of the communications network based on the emulated network performance metrics, prior to live traffic being generated by users on the communications network.

9. The method of claim 8, wherein classifying failures comprises creating scenarios to simulate the failures based on root cause analysis of one or more errors using the emulated network performance metrics.

10. The method of claim 8, comprising identifying potential remedial actions with respect to one or more of the failures.

11. A network performance estimation system for a communications network, comprising:
at least one memory that stores computer executable instructions; and
at least one processor that executes the computer executable instructions to cause actions to be performed, the actions comprising:
obtaining a proposed entire coverage of a service or function of the communications network;
prior to live traffic being generated on the communications network by users subscribed to the service or function:
determining a drive test pattern commensurate with the proposed entire coverage;
causing performance of a plurality of drive tests in accordance with the drive test pattern;
analyzing drive test data from the plurality of drive tests; and
generating emulated network performance metrics for the service or function of communications network based on the analyzing of the drive test data.

12. The system of claim 11, wherein the proposed entire coverage includes an entirety of proposed geographic regions to be served by the service or function upon its deployment.

13. The system of claim 12, wherein determining the drive test pattern comprises identifying publicly accessible surface pathways based on the proposed geographic regions.

14. The system of claim 13, wherein determining the drive test pattern comprises associating respective time windows and drive test devices with different portions of the identified surface pathways.

15. The system of claim 14, wherein the respective time windows and drive test devices are determined based on at least one of a real-time processing constraint, drive test device accessibility constraint, or performance metrics density requirement.

16. The system of claim 11, wherein causing performance of the plurality of drive tests in accordance with the drive test pattern comprises causing performance of at least two of the drive tests in a temporally parallel or partially overlapping manner.

17. The system of claim 11, wherein the emulated network performance metrics emulate key performance indicators (KPIs) that are computed based on live traffic generated by users on the communications network.

18. A non-transitory computer-readable medium storing contents that, when executed by one or more processors, cause actions to be performed, the actions comprising:
obtaining a proposed entire coverage of a service or function of the communications network;
prior to live traffic being generated on the communications network by users subscribed to the service or function:
determining a drive test pattern commensurate with the proposed entire coverage;
causing performance of a plurality of drive tests in accordance with the drive test pattern;
analyzing drive test data from the plurality of drive tests; and
generating emulated network performance metrics for the service or function of communications network based on the analyzing of the drive test data.

19. The computer-readable medium of claim 18, wherein causing performance of the plurality of drive tests in accordance with the drive test pattern comprises causing performance of at least two of the drive tests in a temporally parallel or partially overlapping manner.

20. The computer-readable medium of claim 18, wherein the actions comprise classifying failures of the communications network based on the emulated network performance metrics, prior to live traffic being generated by users on the communications network by users subscribed to the service or function.
